(19) United States
(12) Patent Application Publication
(10) Pub. No.: US 2019/0313484 A1
(43) Pub. Date: Oct. 10, 2019

(54) Method and Apparatus for Dynamic Combination of Heating Element with Object Presence Sensor

(71) Applicants: Robert Cal Wilkes, Richmond Hill (CA); Isaac George Parsons, Calgary (CA)

(72) Inventors: Robert Cal Wilkes, Richmond Hill (CA); Isaac George Parsons, Calgary (CA)

(21) Appl. No.: 16/366,442

(22) Filed: Mar. 27, 2019

Related U.S. Application Data
(60) Provisional application No. 62/652,547, filed on Apr. 4, 2018.

(51) Int. Cl. H05B 6/06

(52) U.S. Cl. CPC H05B 6/062; H05B 2213/03; H05B 2213/07; H05B 2213/05

(57) ABSTRACT

The present invention presents a method and apparatus for the dynamic combination of a heating element and an object presence sensor for the purpose of creating a control loop in which a heating element responds to the detection of any desired material within a measurable range from the heating element. The system described in the previous sentence will be referred to as “cell” for the remainder of this patent. One application of this invention is in cooktops that could dynamically create cooking regions from an array of these cells, allowing users to place pots or pans anywhere on the surface of the cooktop. The ability to create a dynamic grid which only heats up areas which are covered either directly by food or by an intermediate cooking vessel results in a state of the art cooking surface improving upon both the performance and efficiency of its predecessors.

### CROSS-REFERENCE TO RELATED APPLICATIONS

This application claims benefit under 35 U.S.C. 119(e) of U.S. Provisional Patent Application No. 62/652,547, filed Mar. 28, 2018, the entirety of which is incorporated herein by reference.

### BACKGROUND OF INVENTION

### 1. Technological Field

The invention relates to a method and its associated apparatus for the integration of a heating element with an object presence sensor and an array of the same.

### 2. Background

The practice of heating materials has great importance in a variety of applications. One of these applications is cooking food. Over the previous two centuries stove tops have undergone several transformations to meet the changing demands of customers.

In general, two trends are prevalent in the stove top industry. The first is customers are demanding quicker cooking times at a greater power efficiency. The second is customer's demand for restaurant quality food to be prepared at home [2]. While many developments have taken place, all of the current stove tops fail to deliver sufficient functionality. There is a clear need for a stove top which allows users to cook food directly on its surface, in the manner of a flat grill while also operating as a traditional stove top for pots and pans. Furthermore, customers commonly demand more than 4 burners and a dynamic configuration [2].

### 3. Description of Related Technologies

There are four technologies closely related to the current invention being wood burning, gas, traditional resistive electric, and induction stoves.

The first wood burning stoves date back to early civilizations in Egypt and Rome and have not changed significantly since. While these stoves served our ancestors well they lack both efficiency and functionality. While these stoves offer users a traditional experience the cooking times greatly exceed those demanded by today's fast paced life. Additionally, many struggles such as maintaining a constant cooking temperature plague these stoves.

The next innovation in stove top technology to follow wood burning stoves was gas ranges. Gas ranges allow users to deliver both consistent and high power to their food. This means that food can be cooked much faster and with greater accuracy. However, these stoves are plagued by poor efficiency due to poor heat conduction resulting in dissipation of over half of their energy to the surrounding environment [3]. Accessories such as large attachable flat grills allow gas stoves to be transformed into flat grills, however such large accessories are infeasible for the average individual given the decreasing average household size. These stoves tend to be used by cooking enthusiast with large kitchens allowing for the storage of these accessories, as well as the installation of sufficient ventilation. It must be noted that one drawback of these systems tends to be the difficulty in cleaning the cooking surface and therefore prototypes of covered gas burners have been developed but due to further decreased efficiency these prototypes are not suitable for commercialization [2].

The introduction of residential electricity brought about the development of resistive heating electric stoves. These traditional electric stoves are the most common stove in today's market and offer a reasonable balance of performance and efficiency. However, current designs commonly employ 4 burners of fixed sizes. The result is a limitation on how many items can be cooked congruently. Over the previous decade most manufactures have begun to offer models with up to 6 burners but this comes at the cost of increased unit size. Another issue with having fixed size burners is that efficiency of these stoves is directly tied to the relative size of the cooking vessel and the burner, the closer the fit between the two the greater the efficiency but a mismatch in size results in poor performance [3].

The latest innovation in stove top design is induction heating. While the technology has been around since the early 1980s, the high cost of these stove, their incompatibility with both stainless steel and aluminum cooking vessels, and performance shortcomings of early models have led to poor market adoption. More recently, manufacturers have toted safety as the stove surface itself does not heat up. Manufactures have also claimed increased efficiency of induction stoves, but a study commissioned by the California Energy Council largely disproved this claim. The study found that induction heating stoves only outperformed traditional electric stoves when there was a large disparity between the size of the cooking vessel and the burner, but showed that if the cooking vessel is sized correctly the traditional electric stove outperformed the induction heating [3].

Several other innovations have occurred in the peripheries of the stove. The addition of a multitude of sensors has allowed for functionality such a temperature sensing and monitoring of specific cooking situations, such as water boiling. These sensors have been paired with advanced software to enable these functionality as well as communicate with other electronic devices.

### PATENT CITATIONS

| | |
|---|---|
| U.S. Pat. No. 9,784,456 | Electric Stove |
| U.S. Pat. No. 9,740,343 | Capacitive Sensing Array Modulation |
| U.S. Pat. No. 9,775,195 | Capacitive sensing system |
| U.S. Pat. No. 9,654,104 | Resistive force sensor with capacitive discrimination |
| U.S. Pat. No. 9,006,622 | Induction Cooking |
| U.S. Pat. No. 8,410,797 | Capacitive sensor and sensing method |
| U.S. Pat. No. 8,395,379 | Inductive sensor for speed, rotational direction and position |
| | measurements in the high temperature range |
| U.S. Pat. No. 8,258,777 | Inductive proximity sensor |
| U.S. Pat. No. 8,104,354 | Capacitive sensor and manufacturing method thereof |
| U.S. Pat. No. 7,772,960 | Pre-loaded force sensing resistor and method |
| U.S. Pat. No. 7,719,262 | Inductive proximity sensor and related methods |
| U.S. Pat. No. 7,428,901 | Cooking Stove |
| U.S. Pat. No. 7,148,703 | Auto-deep scan for capacitive sensing |
| U.S. Pat. No. 7,019,734 | Resistive Touch sensor having microstructured conductive layer |
| U.S. Pat. No. 6,253,761 | Sensing device for stoves |
| U.S. Pat. No. 5,611,329 | Flameless heater and method of making same |
| U.S. Pat. No. 3,765,100 | Capacitive sensing dryer control |
| U.S. Pat. No. 3,237,608 | Apparatus for heating at least two vessels by a single source of heat |
| U.S. Pat. No. 2,831,951 | Cartridge Heater and Method of Making Same |
| U.S. Pat. No. 2,494,843 | Electric Stove for Heating and Cooling |
| U.S. Pat. No. 2,350,348 | Heat Transfer Device |
| U.S. Pat. No. 2,314,791 | Portable Stove |
| U.S. Pat. No. 746,128 | Electric heating element |
| CA 2,193,533 | Fire prevention device for electric cooking stove |

### PATENT APPLICATION CITATIONS

| | |
|---|---|
| US 20180018038 | Capacitive Sensing for determining mass |
| | displacement and direction |
| US 20170354190 | Heating and Cooling Technologies |
| US 20160306455 | Motion Based Capacitive Sensor System |
| US 20120043970 | Automatic Tuning of a Capacitive Sensing Device |
| US 20030091220 | Capacitive Sensor Device |
| EP 2,672,294 | Object Detection Device |
| EP 348,027 | Magneto-resistive sensor with opposing currents for |
| | reading perpendicularly recorded media |
| WO 1986002447 | Capacitive sensing cell made of brittle material |

### PAPER CITATIONS

[1] E. Hoffmann and A. Chan, “Alternative approaches to the design of four-burner stoves”, Ergonomics, vol. 54, no. 9, pp. 777-791, 2018.

[2] “25 Years of Innovation: Stoves, Cooktops, and Ovens”, This Old House.

[3] M. Sweeney, J. Dols, B. Fortenbery and F. Sharp, “Induction Cooking Technology Design and Assessment”, ACEEE Summer Study on Energy Efficiency in Buildings, pp. 370-379, 2014.

### OBJECTIVE OF THE INVENTION

The objective of the present invention is to disclose a method and associated apparatus for a heating element which responds to the presence of conductive and non-conductive materials placed within close proximity of the heating element. The present invention describes a cell composed of an integrated object detection sensor and heating element.

These cells can be combined to form arrays that act in coordination. Such arrays of these cells can be utilized for applications such as cooktops.

### SUMMARY OF THE INVENTION

A method and its associated apparatus for a heating element that is controlled in response the detection of non-conductive and conductive materials by proximity of the sensor.

The apparatus can employ either an optical sensor, capacitive sensor, inductive sensor, resistive sensor, strain gauge, mechanical sensor or a combination of the aforementioned sensors to detect the presence of a medium intended to be heated, however these detection sensing methods are not meant to be considered limiting.

The device can utilize either a microwave heating element, gas heating element, resistive electric heating element, inductive heating element, a combination of the aforementioned heating elements, or a plurality of the aforementioned heating elements to deliver heat to an object once detected however these methods of heating the detected object are not meant to be considered limiting.

Finally, the arrangement of a plurality of the aforementioned cells to demonstrate how the cells can be used collectively to create products such as dynamic cooktops.

### BRIEF DESCRIPTION OF FIGURES

FIG. 1a is a cross-sectional view of a cell.

FIG. 1b provides a top view of a cell.

FIG. 2 is an isometric view of a plurality of cells and the accompanying electronics required to form a cooktop.

### DETAILED DESCRIPTION OF PREFERRED EMBODIMENTS

For the purpose of promoting an understanding of the principles of this invention, reference will now be made to the embodiments illustrated in the figures and specific terminology will be used to describe these embodiments. It will be nonetheless understood that no limitation on the invention's scope is intended.

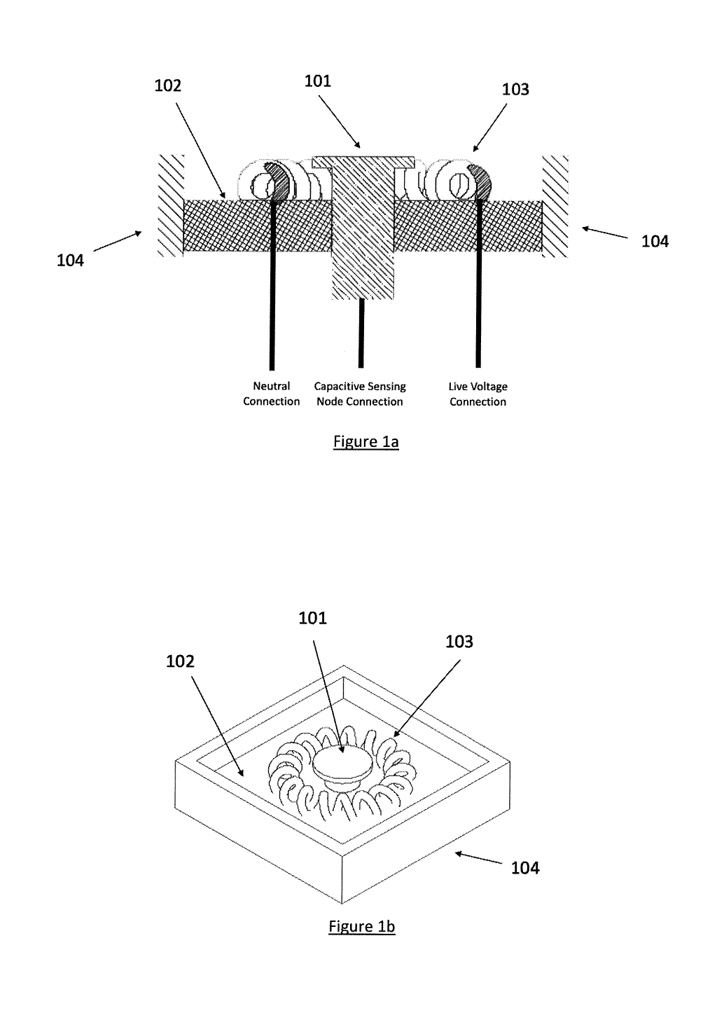

The invention combining at least one object detection sensor and a heating element in its singular form will be referred to as a cell. Each cell can range is shape and size, thus the cell shown in FIG. 1 one of many possible embodiments.

The object detection sensor of the cell can be implemented using optical, electrical, mechanical, chemical sensors, or a combination of the aforementioned sensing methods.

In FIG. 1, the cell's object detection sensor is implemented using an electrically conductive metallic capacitive sensing node 101. Capacitive sensing makes it possible to detect the presence of both conductive and non-conductive materials within 1 meter of the sensor, using circuits and signal processing algorithms known in the arts. The potting material 102 is used to electrically insulate the capacitive sensing node from all other conductors in the environment.

In the event that an object is detected by the object detection sensor of the cell, the system either automatically engages the heating element or alerts users through a user interface, allowing them to manually engage the heating element.

The heating element can be implemented using electrical, mechanical or chemical heat producing sources.

In FIG. 1, the heating element of the cell is implement using a radiant heating coil 103. The operation of radiant heating coils is known in the arts.

The cell's control system can be implemented using a computer capable of monitoring the capacitance of the capacitance sensing node 101 and controlling the power dissipated by the radiant heating coil 103 of the cell. The computer as well as appropriate sensing and control circuits are connected to the cell via the shown connections, 1 for the capacitance sensing nodes 101 and 2 for the power source for the radiant heating coil 103.

The cell is contained by a metallic shell 104.

A plurality of these cells can be arranged in a two-dimensional array to form a continuous cooktop that is capable of dynamically heating independent areas where objects are detected on its cooking surface. The cells are combined in a structured format so that their operation is coordinated. To do so a more sophisticated control system is required. The architecture discussed in this section is not meant to be limiting but is used the provide an understand as to how these cells can be combined effectively.

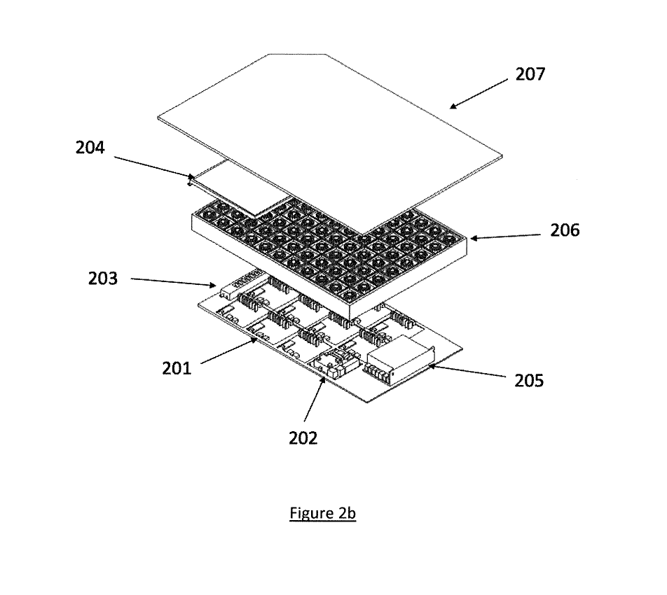

FIG. 2 illustrates the system's architecture that includes Local Control Units (LCUs) 201, a Central Control Unit (CCU) 202, a communication link 203, a touchscreen 204 and a power supply 205 that combine to control the array of cells 206 that heat the cooking surface 207.

The LCUs 201 are comprised of a single micro-computer and the circuits responsible for monitoring the object detection sensors and controlling the power output to the heating elements for a sub-group of population of cells. In the presented embodiment, each LCU is responsible for controlling the operation of 8 cells.

The CCU 202 is a more powerful general-purpose computer that communicates with all the LCUs 201 of the system, via the communication link 203, to effectively control the entire array of cells 206.

The LCUs 201 send object detection data from the cells to the CCU 202. The cumulative data from all of the object detection sensors allows for both spatial and time-based algorithms to be implemented for object detection and tracking. Machine learning algorithms can be implemented to further predict the various characteristics of objects placed on the cooking surface 207 based on data acquired by the cells.

The CCU 202 also services the inputs and outputs from the touchscreen 204, that acts as the user's interface for this embodiment. The touchscreen 204 provides users with complete control over the system and can be customized to include a wide variety of software application for cooking. The touchscreen 204 allows users to adjust temperatures of the detected cooking regions and also form custom shaped and sized cooking regions independently of the object detection portion of the system.

With the data from the object detection sensors and the user interface the CCU 202 determines the states of the outputs and communicates the desired heating element outputs to each of the LCUs 201, that in turn control the heating elements of the individual cells. This provides the system with high resolution control over the cooking areas that can be created on its cooking surface 207.

The array of cells 206 illustrated in FIG. 2 is comprised of 2-dimensional arrangement of individual cells. This embodiment provides further justification thermally isolated by their metallic shells 104. The potting material 102 provides both electrical insulation, to isolate the capacitance sensing nodes 101 so they each operate independently and thermal insulation to mitigate heat dissipation in the direction of the system's sensitive electronics. The shape and size of this array of cells 206 can be customized as a result of the modular design and flexible control algorithms.

The power supply 205 is responsible for supplying all voltage levels required to power the array of cells 206, LCUs 201, CCU 202 and the communication link 203.

The cooking surface 207 is constructed from a thermally and biologically suitable material for cooking.

What is claimed is:

1. A system for detecting the proximity of materials and applying heat to the same object, said system comprising an integrated unit that comprises: (a) at least one object presence sensor, (b) at least one heating element, (c) the circuitry required to control the output of the heating element and (d) a computing unit to implement the control system. The system shall be referred to as a “cell”.

2. The system of claim 1 wherein the object detection sensor is capable of sensing both conductive and non-conductive materials.

3. The system of claim 1 wherein the object detection sensor is monitored by circuitry and a computing unit to detect the presence of objects and trigger an event when objects come within a predetermined distance of the sensor.

4. The system of claim 1 wherein the heating element is automatically turned on when the object presence sensor triggers an event.

5. The system of claim 1 wherein the user feedback is used to manually turn on the heating element when the user is made aware of the detection event indicated by the object presence sensor.

6. The system of claim 1 wherein the heating element can be control by appropriate circuitry and a computing unit to provide at least 2 different power output levels.

7. The system of claim 1 wherein the object presence sensor is physically separated from the object being detected.

8. The system of claim 1 wherein the object being heated is not in direct contact with the heating element.

9. A system comprised of an array of 2 or more cells (the system of claim 1) that function collectively to detect objects and heat the same object.

10. The system of claim 9 wherein all of the object presence sensors of each cell is isolated from the rest.

11. The system of claim 9 wherein the heating elements can be controlled independently of the object presence sensors by a user interface.

12. The system of claim 9 wherein each heating elements power output can be individually controlled.

13. The system of claim 9 wherein the object presence sensor data from multiple object presence sensors is used to determine whether or not a sensing event should be triggered for a single cell.

14. The system of claim 9 wherein the heating elements and object presence sensors do not need to exist in a one to one ratio.

15. The system of claim 9 wherein an object can be tracked in software as it moves across multiple cells of the array.

16. The system of claim 9 wherein a subset of cells of array can be controlled by a computing unit capable of coordinating with other at least one or more other computing units that similarly control other subsets of the population of cells.

17. The system of claim 9 wherein a central computing unit can oversee multiple local computing units which can each control multiple cells.

18. The system of claim 9 wherein objects can be tracked as they move over the array of cells.

19. The system of claim 9 wherein at least two or more objects can be detected and heated in parallel.

20. The system of claim 9 wherein at least two or more objects on the array of cells can be heated to different temperatures.

21. The system of claim 9 incorporated into a cooktop.
